(19) United States
(12) Patent Application Publication
(10) Pub. No.: US 2025/0257946 A1
(43) Pub. Date: Aug. 14, 2025

(54) SYSTEMS AND METHODS TO MEASURE OXIDATION LOSSES OF FURNACE ELECTRODES

(71) Applicant: CHEMTREAT, INC., Glen Allen, VA (US)

(72) Inventors: Douglas A. GODWIN, Fairhope, AL (US); Alan J. FELLER, Macy, IN (US); Michael PITZ, Farmington Hills, MI (US)

(73) Assignee: CHEMTREAT, INC., Glen Allen, VA (US)

(21) Appl. No.: 19/047,148

(22) Filed: Feb. 6, 2025

Related U.S. Application Data
(60) Provisional application No. 63/551,818, filed on Feb. 9, 2024.

(51) Int. Cl. F27D 21/00; F27D 9/00; F27D 11/10

(52) U.S. Cl. CPC F27D 21/00; F27D 11/10; F27D 2009/0016

(57) ABSTRACT

Methods and systems are described for measuring and evaluating the consumption of graphite electrodes that are used to melt raw materials in furnaces. A dimension of a tapered region of the electrode can be measured, e.g., with a laser distance measuring instrument, and the volume loss of the electrode can be calculated based on the measured dimension. One or more corrective actions can be taken to reduce the electrode consumption losses.

### CROSS-REFERENCE TO RELATED APPLICATIONS

This application claims the earlier filing date benefit of U.S. Provisional Application No. 63/551,818, filed on Feb. 9, 2024, which is incorporated by reference herein.

### TECHNICAL FIELD

This disclosure relates generally to techniques for measuring electrode consumption of graphite electrodes that are used in used in a furnace, and to controlling operational parameters of the furnace and/or cooling water system to reduce electrode consumption.

### BACKGROUND

Steel producers use electrical energy to melt raw materials to produce 1 ton to 420 metric tons of steel in vessels. Electrical energy can be delivered to the furnace(s) as alternating current (AC) or direct current (DC). For example, the electrical power delivered to the raw materials can be as high as 200 MWh in the case of the largest electric arc furnace (EAF) vessels. This power supply creates an electrical arc that creates the necessary heat to raise the batch of steel to temperatures as high as 1800° C. and to allow for further refinement and processing in the ladle metallurgy furnace (LMF) and subsequent casting, refining, and/or forming operations.

The electrical power is delivered to the steel through graphite electrodes. Graphite is the material of choice for electrodes due to the following characteristics: low coefficient of thermal expansion (CTE), high tensile strength, high specific resistance, electrical resistance that is relatively independent of temperature, and nobility (cathodic to other materials).

Electrodes are consumables utilized in the electrical steel making process and account for a substantial cost for the steel maker. The environment in the electric arc furnace is violent and harsh, and causes consumption of electrodes in a range of approximately 0.8 kg/metric ton of steel produced to 4 kg/metric ton. Causes of consumption include: sublimation of the electrode from the electrical arc at the electrode tip where localized temperature is approximately 3000° C.; electrode breakage due to torqueing of the electrode, failures with adding equipment, or movement of the raw materials; thermal shock and subsequent loss of electrode tip; and oxidation of the electrode surfaces along the column due to the harsh furnace environment. Oxidation of the electrode creates the conical shape of electrodes that are in use and can account for nearly 50% of the electrode consumption.

For decades, steel producers and furnace electrode producers have attempted to reduce the oxidation rate of the graphite and carbon electrodes through many different means. One example is to use electrodes that have surfaces coated with layers formed from graphite, metal, aluminum alloys, and pure aluminum. However, these coatings are only applied once (e.g., only during the manufacturing of the electrodes or on-site but before the electrode is put into service), and the coatings are susceptible to chemical and physical damage that renders them ineffective. Thus, these types of coatings can have short useful life spans.

Changes in the electrode manufacturing process, in electrode coupling technology, in the recipe for the graphite electrodes, and in operational procedures like foamy slag have substantially reduced electrode consumption since 1985 when electrode consumption was between 5 to 6 kg/metric ton of steel, to 0.8 to 2.5 kg/metric ton of steel in 2018. While this has been an impressive reduction, market forces have heightened sensitivity to the consumption rate. Even incremental decreases in consumption rate have a substantial impact to the steel maker.

The oxidation of the electrode is a chemical reaction. The rate of oxidation of the electrode increases with increasing temperatures because the reactant molecules have more kinetic energy at higher temperatures. The reaction rate (i.e., oxidation rate) is governed by the Arrhenius equation which in almost all cases shows an exponential increase in the rate of reaction as a function of temperature.

$$k = \frac{- Ea}{{k}_{B} T}$$

Where: k=the rate constant
k_{B}=Boltzmann constant
T=absolute temperature
Eₐ=the activation energy

Therefore, many designs have been developed to cool the bulk of the electrode (i.e., lower the temperature of the electrode), but have been abandoned due to safety concerns. Applying cooling water to the electrode below the molten steel bath creates a very dangerous condition in the case of an electrode break or the failure of the cooling water channel. The release of cooling water below the steel bath creates an explosion due to the rapid expansion as the water changes phase from water to steam with an approximate volumetric expansion of 1,100 times. Electrodes used in commercial steel making are currently composed exclusively of graphite and do not contain internal cooling water channels.

To further reduce oxidation of the electrode, spray cooling was introduced to the industry and specific designs were developed to cool the electrode using one or more circular spray headers, optionally with vertical spray headers located at multiple locations around the circumference of the electrode above the furnace. The use of spray cooling water to reduce electrode oxidation losses has been extensively adopted in the steel-making industry. Recently, Applicant introduced a technique for substantially reducing electrode sidewall oxidation by introducing an additive to the spray water cooling system that forms an antioxidant barrier coating on the electrode surface while the electrode is hot, including when the electrode is in use melting raw materials.

Existing methods of determining furnace electrode consumption tend to require excessive maintenance, are overly complicated, and/or are not very reliable.

### SUMMARY

This disclosure provides systems and methods for simply and accurately measuring furnace electrode consumption to determine whether a corrective measure is needed. Accordingly, in embodiments, the systems and methods described herein can even further decrease the oxidation rate of furnace electrodes by controlling one or more operational parameters based on the measured electrode loss.

According to one aspect, this disclosure provides a method for measuring volume loss of a graphite electrode that has been used to melt raw materials in a furnace. The electrode includes a tapered region, e.g., from oxidation losses. The method includes (i) measuring at least one dimension of the electrode within the tapered region with a laser distance measurement instrument; and (ii) based on the at least one measured dimension, calculating the volume loss of the electrode.

According to another aspect, this disclosure provides a method for evaluating consumption of a graphite electrode during periods in which the electrode is used to melt raw materials in a furnace and is sprayed with an aqueous cooling liquid from a spray cooling system. The method includes (i) after one or more of such periods of melting raw materials, measuring a property of the electrode with one or more of the following: a laser distance measurement instrument, a touch probe, a digital camera, a scale, and a load cell; (ii) based on the measured property, calculating the consumption of the electrode; and (iii) then, based on the calculated consumption of the electrode, adjusting an operational parameter of the furnace and/or spray cooling system during a subsequent period in which the electrode is used to melt raw materials in the furnace.

According to a further aspect, this disclosure provides a system for operating a furnace that melts raw materials with a graphite electrode. The system includes (i) a spray cooling system that is configured to spray a portion of the electrode with a cooling liquid that includes water and optionally includes one or more additives; (ii) a measuring instrument that is configured to measure a property of the electrode after it is used to melt raw materials; and (iii) at least one controller that is programmed to calculate a loss of the electrode based on the measured property and to send a signal to control at least one operational parameter of the spray cooling system based on the calculated loss.

### BRIEF DESCRIPTION OF THE DRAWINGS

FIG. 1 is a schematic diagram illustrating a furnace electrode that is in service melting raw materials.

FIG. 2 is a schematic diagram illustrating a system for measuring the consumption of an electrode in one embodiment.

FIG. 3 is a schematic diagram illustrating a system for determining the volume losses a furnace electrode according to one embodiment.

### DETAILED DESCRIPTION OF EMBODIMENTS

The disclosed methods and systems may be used to measure and quantify electrode losses after the electrode is used to melt raw materials, e.g., by measuring electrode dimensions to determine a volume loss, and to facilitate one or more changes to the operation of the furnace, electrode, and/or spray cooling system based on the amount of electrode loss. The electrodes can be any furnace electrode that experiences volume losses while in-use melting raw materials, including graphite electrodes that are used in furnaces such as an electric arc furnace (EAF), ladle metallurgy furnace (LMF), ladle metallurgy station (LMS), polysilicon furnace, induction furnace, vacuum induction melting, argon oxygen decarburization, vacuum oxygen degassing, vacuum degassing, vacuum arc remelting, and electro slag remelting, for example.

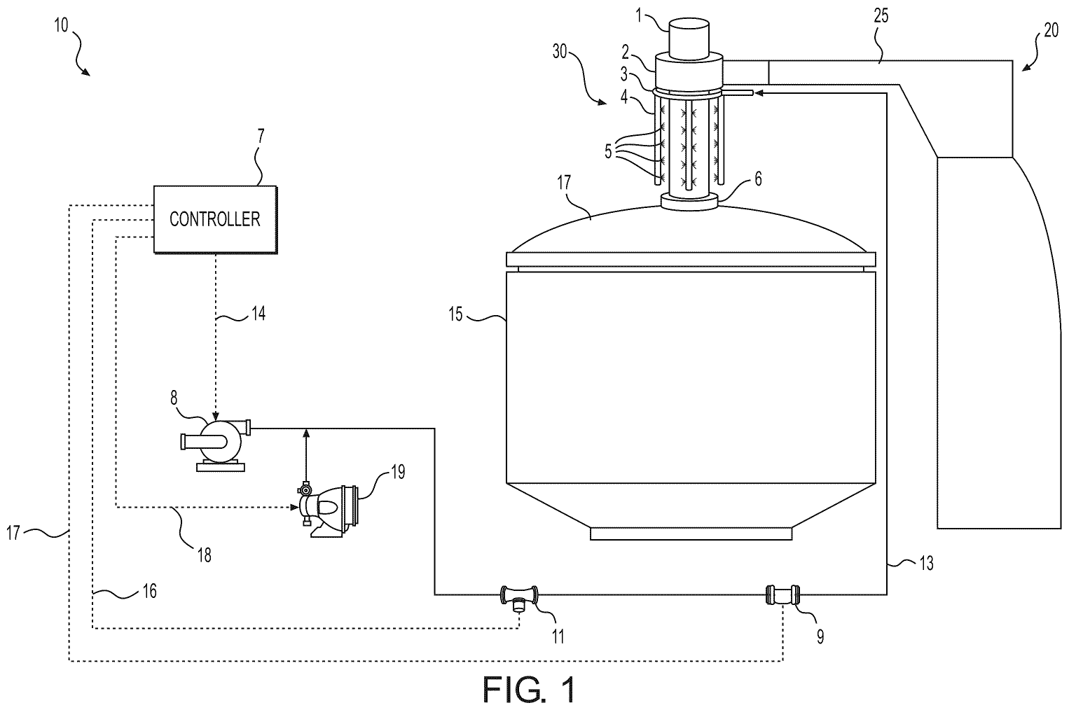

FIG. 1 illustrates an example of a typical system 10 for operating a direct current furnace 15 to melt raw materials with a graphite electrode 1. Alternating current furnaces have multiple electrodes arranged in the furnace, but are otherwise similar. In system 10, an electrode holder 2 that is connected to electrode mast 20 by mast arm 25 holds a graphite electrode 1 which extends into the furnace 15 through the top of the furnace 6 (i.e., the delta). The size of a graphite electrode 1 can typically vary from 75 mm to 700 mm in diameter, although electrodes of up to 800 mm are available. Cooling water can be pumped through flow path 13 via pump 8 (e.g., a booster pump) to the spray cooling header/arrangement 30. As used herein “cooling water” refers to any liquid that is at least 95 wt. % water that is sprayed onto the surface of the furnace electrode, and this disclosure expressly contemplates that the cooling water can include one or more additives, e.g., including those that form an antioxidant coating and/or enhance the visibility or detectability of the spray pattern. A control valve 9 can regulate the flow of spray cooling water to the header 30 based upon signal 17 from a controller 7, such as a distributed control system (DCS). An in-line flow meter 11 can measure the flow rate of cooling liquid in flow path 13 and send a signal 16 to the controller 7 that actuates a pump 8 (e.g., a booster pump) to control the supply of cooling water. In this embodiment, the spray cooling header 30 (i.e., the cooling bank) has a circular ring distribution header 3 and a vertical spray distribution header 4. The vertical spray distribution header 4 includes a plurality of orifices 5 from which the cooling water is sprayed onto the outer circumference of the electrode 1. In this manner, direct cooling of the electrode occurs from the electrode holder 2 to the top of the furnace 6. In most facilities, the cooling water is constantly applied to the electrodes while the electrode is in use and receiving electric power to actively melt raw materials such as steel. Since the oxidation rate of graphite increases exponentially with temperature, the cooling water reduces the sidewall oxidation of the electrode by cooling the electrode during use.

As shown in FIG. 1, the spray cooling water system 10 can include one or more chemical injection pumps or chemical metering skids 19 that supply one or more additives to flow path 13. The cooling water with the additive(s) is sometimes referred to herein as “chemically modified cooling water”. The controller 7 can control the addition of the additive(s) by sending signals 18 to the dosing unit. Where more than one additive is used, the controller 7 can also control the ratio of additives that are combined with the cooling water. Suitable additives and techniques for adding and controlling the addition of additives to the cooling water flow path 13 to reduce electrode oxidation losses are described in detail in Applicant's U.S. Pat. No. 10,694,592, which is incorporated by reference herein in its entirety.

In operation, the graphite electrode 1 is electrified to melt raw materials that have been added to the furnace. In some facilities, the mast arm 25 can be rotatable with respect to the furnace position, e.g., by being mounted to a rotatable platform. At certain times, the electricity to the electrode 1 is turned off, and the mast 20 can be operated to lift the hot electrode 1 out of the furnace 15 and then position the hot electrode 1 in a holding area. In some facilities, the electrode may be moved out of the furnace in a different manner. By way of example, the electrode can be removed when the furnace needs to be tapped and/or recharged with raw materials, when the graphite electrode needs to be advanced through the electrode holder, or when a new electrode segment needs to be added. These periods between heats where the electrode is still hot are referred to as “dwell time.” In one aspect of the invention, the volume loss of the electrode 1 can be determined by measuring dimensions of the electrode during the dwell time while a tapered region of the electrode is still red hot (e.g., more than 700° C. or more than 1,000° C.). The dimensions of at least a portion of the tapered region can be measured at any point during the dwell time, including while the electrode is in the holding area or when the lid 17 has been removed from the furnace. In other aspects, the dimensions of the tapered region can be measured at any time after the electrode has been used, including during outages or other downtime or when the electrode has cooled or is off-line.

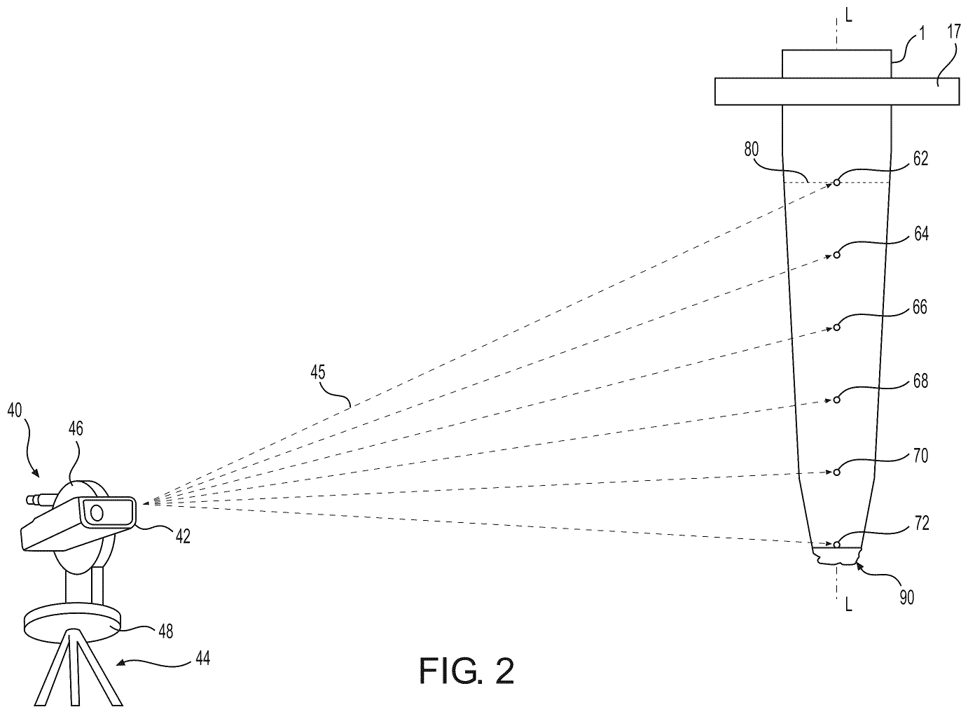

Before it is used to melt raw materials, the electrode 1 has a cylindrical shape with a standard or known diameter. When the electrode 1 is electrified and used to melt raw materials, it experiences significant sidewall oxidation. FIG. 2 shows the effect of the sidewall oxidation on electrode 1 where the electrode 1 becomes tapered due to the oxidation losses, and takes on a conical or frustoconical shape. According to aspects of this invention, the electrode consumption can be quantified by measuring the dimensions of this tapered region, and the total volume loss from the original cylindrical shape or from a previously calculated electrode volume can be determined.

In one aspect, the electrode dimension can be measured using laser point-to-point technology in which a laser is used to determine the electrode diameter along the electrode length. FIG. 2 schematically illustrates an example of using laser point-to point technology to measure the volume losses of an electrode 1 after a heat. In this example, a laser point-to-point unit 40 includes a laser source/receiver 42, a first rotary encoder 46, and a second rotary encoder 48. The unit 40 can be mounted on a tripod 44 or can otherwise be made to be stationary while measurements are taken. The laser source/receiver 42 can emit a laser beam 45 to a plurality of target points 62, 64, 66, 68, 70 along the length of the electrode 1 and can receive reflected light from these points to calculate the distance of each point from the laser source/receiver 42 based on the time it takes for the beam to reflect back. The distance correlates with the diameter of the electrode 1 at the given target point. The unit 40 can also include a camera and display (not pictured) to assist in targeting the laser beam 45, and can include a user input section where a user can enter information.

Before taking a measurement, the unit 40 can be calibrated by pointing the laser source/receiver 42 at a portion of the electrode that is not tapered (e.g., at or above line 80), and entering the known diameter of the electrode. This measurement can act as a baseline from which the diameter of the electrode at points along the tapered section of the electrode can be determined. In some embodiments, once the untapered point is measured, the known diameter can be entered into a point-to-point laser measurement device and the device can thereafter automatically calculate the diameter at other measurement points.

In some embodiments, it may be desirable to start measuring the electrode diameter from the top of the tapered portion. If so, several measurements can be taken along the length axis L of the electrode 1 at the upper portion of the electrode 1 to determine the taper line 80 where the taper begins. It can be assumed that the taper begins where the diameter of the electrode 1 begins to change or where the diameter changes by a threshold amount along the length axis. The measurements of points 62, 64, 66, 68, 70, and 72 along axis L can then be taken.

In other aspects, it is not necessary or may not be possible to measure along the entire length of the tapered region, and it is not necessary or may not be possible to measure from the start of the taper line 80 or otherwise to take a measurement at an untapered location. Accurate electrode losses can still be determined by measuring only part of the tapered region. For example, by taking two or more measurements along the tapered region, the slope of the electrode along the tapered region can be estimated, and the point at which the electrode diameter equals its known or standard diameter can be extrapolated, which could be used to calibrate unit 40 to determine the diameter at other measurement points along the tapered region and/or to determine the overall electrode consumption. Likewise, the location of the tip of the electrode could be extrapolated based on the slope, which could be used to determine the diameter at other measurement points along the tapered region and/or to determine the overall electrode consumption.

The unit 40 can combine angle information from rotary encoders 46, 48 and distance data from points 62, 64, 66, 68, 70, 72, to calculate the electrode diameter at these various positions on the length axis L. In some embodiments, a separate computer or CPU can receive the distance measurement data from unit 40 and can be programmed to calculate the electrode diameter at the various points. In general, suitable data to calculate electrode consumption may be obtained by taking data from 1 to 30 points, from 4 to 20 points, or 5 to 15 points, for example. The points can be evenly spaced along axis L of the electrode 1, but need not be on the same vertical axis and need not be evenly spaced. If the slope of the taper changes along the length of the electrode, it is preferred to measure the diameter at boundaries where the taper slope changes. In some aspects, it is not necessary to take a measurement at the tip portion 90 since the geometry of the tip portion 90 is not regular and includes losses primarily from sublimation and tip breakage.

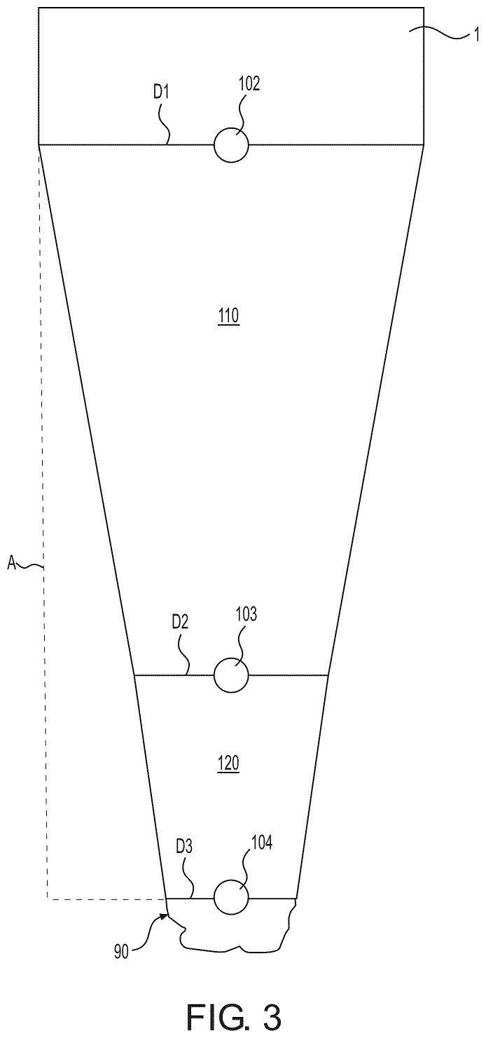

FIG. 3 further illustrates how the volume of the electrode losses can be quantified. In this example, the point-to-point unit 40 takes distance measurements at target points 102, 103, and 104, and records the angular data from the rotary encoders 46, 48 at each measurement. Once the point-to-point unit 40 is calibrated (e.g., as described above), the unit 40 can determine the diameters D1, D2, and D3 of the electrode based on the measured distances and angular data. From this, the volume of frustoconical section 110 can be determined and the volume of frustoconical section 120 can be determined based on the measured diameters and the distance between the measurement points (i.e., the height of the frustum). The total volume of the tapered electrode portion is the sum of volumes of segments 110 and 120. The volume electrode loss can by calculated subtracting this sum from the total volume A of an untapered electrode of the same length (i.e., cylindrical volume). The electrode losses can also be represented as a volume percentage or converted to a mass percentage.

The dimension of the tapered electrode portion does not need to be measured along its entire length to accurately correlate electrode losses. For example, the electrode losses in FIG. 3 could be determined based only on measured diameters D1 and D2, or based only on diameters D2 and D3, since the contour of the tapered portion outside of those target points can be extrapolated, as explained above. Similarly, as mentioned above, it is not necessary to measure the electrode at the start of the tapered portion or at the end of the tapered portion. And, in some cases, it may also be possible to correlate electrode losses over several heats with other process variables, as described below, by measuring the diameter at only one location on the tapered region. It may also be possible to determine electrode loss by measuring a slope of the tapered portion of the electrode instead of directly measuring the diameter.

This system allows for electrode losses due to oxidation to be accurately determined after one or more heats. Here also, the measurement data can be transmitted to a controller, such as a processor or CPU, which may or may not be part of the DCS, and then the volume electrode loss can be calculated by the controller.

As an alternative to a point-by-point laser distance measurement, it would be possible to scan the tapered section of the electrode with laser scanning equipment that can scan the electrode surface with a laser beam continuously (or nearly continuously) to measure the electrode diameter along its length.

The laser distance measurement techniques described above can provide highly accurate measurements of the electrode consumption that are sensitive to even small losses, and are surprisingly effective even when the electrode is red hot. The laser measurement unit can also work at a significant distance away from the electrode, e.g., from 2 meters to possibly up to 300 meters, or from 4 meters to 100 meters, or from 5 m to 50 m, for example. This allows the system to be set up out of the way of the furnace operation. The laser measurement unit can also be portable so that it can be moved to take measurements as needed and can accurately take measurements from different positions. Also, in some aspect, the temperature of the electrode can be measured with the laser measurement unit at the same time that diameter is measured.

In some embodiments, measurement techniques other than laser distance measurement may be suitable to measure a property of the electrode that corresponds to electrode loss. For example, it could be possible to measure the volume of electrode loss using touch sensing probes that contact the tapered portion of the electrode at discrete points or continuously, to determine the electrode loss by using scales or load cells to weigh the electrode at various times to determine the weight loss and to calculate the volume loss based on the density of the electrode, and it may also be possible to image the tapered electrode, e.g., with a digital camera, and calculate the volume of the tapered section by computer analysis that measures dimensions in the image.

A controller can also be programmed to correlate the electrode losses over multiple heats with one or more variables in the furnace operation and/or spray cooling system operation. For example, the calculated electrode losses can be correlated with one or more of the following furnace operation variables: electrical energy (kWh), current (kA), power on time, I²T (current squared through time), oxygen lance usage, burner oxygen usage, the raw materials scrap mix, slag practices, steel grade(s) being produced, natural gas injection rate, flux type and amount, draft velocity, draft volume, delta life, delta temperatures, and impedance.

The calculated electrode losses can also be correlated with the flow rate of cooling liquid sprayed onto the electrode during the heat, the amount of any additive(s) added to the cooling liquid, and the type of additives added to the cooling liquid.

In some embodiments, based on the calculated electrode losses and/or the correlations described above, a corrective action can be taken. For example, if the electrode losses exceed a threshold amount, one or more operational parameters of the furnace and/or spray cooling system can be changed in subsequent heats to reduce oxidation of the electrode. In particular, it is contemplated that the following variables can be adjusted in subsequent heats to reduce sidewall oxidation of the electrode: (i) the flow rate of the spray cooling liquid; (ii) the amount of an antioxidant additive added to the spray cooling liquid; (iii) the type of antioxidant additive added to the spray cooling liquid; and/or (iv) a ratio of two or more additives that are added to the spray cooling liquid. This process can control can be done by the operator or a controller can be programmed to automatically adjust these variables based on measurement data of the electrode losses by sending signals to the DCS.

It will be apparent to those skilled in the art that variations of the processes and systems described herein are possible and are intended to be encompassed within the scope of the present invention.

What is claimed is:

1. A method for measuring volume loss of a graphite electrode that has been used to melt raw materials in a furnace and includes a tapered region, the method comprising:
(i) measuring at least one dimension of the electrode within the tapered region with a laser distance measurement instrument; and
(ii) based on the at least one measured dimension, calculating the volume loss of the electrode.

2. The method of claim 1, wherein the measuring step includes measuring a plurality of diameters at respective locations on the tapered region that are separated along a length direction of the electrode.

3. The method of claim 1, wherein the laser distance measurement instrument includes a point-to-point laser measurement instrument.

4. The method of claim 1, wherein the laser distance measurement instrument includes a laser source and a laser receiver, and wherein, during the measuring step, the laser source emits a laser beam that reflects off the electrode and a reflected laser beam is received by the laser receiver.

5. The method of claim 4, wherein, during the measuring step, the laser distance laser distance measurement instrument calculates the at least one dimension based on the time it takes for reflected laser beam to be received by the laser receiver.

6. The method of claim 4, wherein the laser distance measurement instrument includes at least two rotary encoders.

7. The method of claim 1, wherein the laser distance measurement instrument includes a laser scanning instrument that can continuously measure the diameter of the electrode within the tapered region along a length direction of the electrode.

8. The method of claim 1, wherein the tapered region of the electrode has a surface that is at least 700° C. during the measuring step.

9. The method of claim 1, wherein the tapered region of the electrode has a surface that is at least 1,000° C. during the measuring step.

10. The method of claim 1, wherein the diameter of the electrode is measured with the laser distance measurement instrument from a distance that is in a range of from 2 m to 300 m from the electrode.

11. The method of claim 1, wherein the diameter of the electrode is measured with the laser distance measurement instrument from a distance that is in a range of from 4 m to 100 m from the electrode.

12. A method for evaluating consumption of a graphite electrode during periods in which the electrode is used to melt raw materials in a furnace and is sprayed with an aqueous cooling liquid from a spray cooling system, the method comprising:
(i) after one or more of the periods, measuring a property of the electrode with at least one of: a laser distance measurement instrument, a touch probe, a digital camera, a scale, and a load cell;
(ii) based on the measured property, calculating the consumption of the electrode; and
(iii) then, based on the calculated consumption of the electrode, adjusting an operational parameter of the furnace and/or spray cooling system during a subsequent period in which the electrode is used to melt raw materials in the furnace.

13. The method of claim 12, further comprising correlating the calculated consumption of the electrode with at least one value corresponding to the operational parameter of the furnace and/or spray cooling system during the periods.

14. The method of claim 12, wherein the adjusting step includes adjusting a flow rate of the aqueous cooling liquid in the spray cooling system.

15. The method of claim 12, wherein the adjusting step includes adjusting an amount of an additive that is included in the aqueous cooling liquid.

16. The method of claim 12, wherein the adjusting step includes adjusting a ratio of two or more additives that are included in the aqueous cooling liquid.

17. The method of claim 12, wherein, the property of the electrode that is measured is an electrode diameter in a tapered region of the electrode.

18. The method of claim 17, wherein the electrode diameter is measured with the laser distance measurement unit.

19. The method of claim 18, wherein the tapered region of the electrode has a surface that is at least 700° C. when it is measured.

20. A system for operating a furnace that melts raw materials with a graphite electrode, the system comprising:
(i) a spray cooling system that is configured to spray a portion of the electrode with a cooling liquid that includes water and optionally includes one or more additives;
(ii) a measuring instrument that is configured to measure a property of the electrode after it is used to melt raw materials; and
(iii) at least one controller that is programmed to calculate a loss of the electrode based on the measured property and to send a signal to control at least one operational parameter of the spray cooling system based on the calculated loss.
